(19) United States
(12) Patent Application Publication
(10) Pub. No.: US 2014/0209795 A1
(43) Pub. Date: Jul. 31, 2014

(54) HIGH RESOLUTION FAST TUNABLE FILTER USING A TUNABLE COMB FILTER

(71) Applicant: Optoplex Corporation, Fremont, CA (US)

(72) Inventor: Yung-Chieh Hsieh, San Jose, CA (US)

(73) Assignee: Optoplex Corporation, Fremont, CA (US)

(21) Appl. No.: 14/242,326

(22) Filed: Apr. 1, 2014

Related U.S. Application Data
(63) Continuation-in-part of application No. 13/150,404, filed on Jun. 1, 2011.
Application No. 13/150,404 is a continuation-in-part of application No. 11/360,959, filed on Feb. 22, 2006, now abandoned.
(60) Provisional application No. 61/807,302, filed on Apr. 1, 2013.
(60) Provisional application No. 61/350,109, filed on Jun. 1, 2010.

(51) Int. Cl. G02B 26/00; G01J 1/04

(52) U.S. Cl. CPC G02B 26/001; G01J 1/0488
USPC 250/226; 359/578; 359/566; 359/572

(57) ABSTRACT

High resolution fast tunable optical filters are described such that each filter includes a tunable single-peak narrow-bandwidth (SPNB) filter and a tunable etalon in tandem with the tunable SPNB filter, where the bandwidth of the tunable SPNB filter is less than the free spectral range (FSR) of the tunable etalon.

### CROSS-REFERENCE TO RELATED APPLICATIONS

This application claims the benefit of U.S. Provisional Patent Application No. 61/807,302 titled “High Resolution Fast Tunable Filter Using a Tunable Comb Filter,” filed Apr. 1, 2013, and incorporated herein by reference. This is a continuation-in-part of U.S. patent application Ser. No. 13/150,404, filed Jun. 1, 2011, and incorporated herein by reference. U.S. patent application Ser. No. 13/150,404 is a continuation-in-part of U.S. patent application Ser. No. 11/360,959, filed Feb. 22, 2006, and incorporated herein by reference. U.S. patent application Ser. No. 13/150,404 claims the benefit of U.S. Provisional Patent Application No. 61/350,109, filed Jun. 1, 2010, incorporated herein by reference.

### BACKGROUND OF THE INVENTION

1. Field of the Invention

The present invention relates to a super narrow band tunable filter used for optical spectrometer scanning engines.

2. Description of Related Art

Most of the tunable filters available on the market today are based on either angle tuning or axial scanning. An axial scanning method utilizes a Fabry Perot etalon having a transmission curve as a comb filter. When the optical path length of an etalon changes by a distance equal to one half of a wavelength, the wavelength of the transmission peak of the etalon shifts by one free spectral range (FSR) of the etalon. Because of the periodicity of an etalon, the cavity length needs to be so thin that only one transmission peak presents within the tuning range. In essence, FSR must be greater than the tuning range. The Finesse is the ratio of FSR to the full width at half maximum (FWHM) of the transmission profile. Therefore, the combination of large FSR and small FWHM means an extremely high Finesse or reflectivity is required. For instance, for a FSR of 6000 GHz, and FWHM of 20 GHz, the Finesse needs to be 300.

In the angle-tuning method, the incidence angle to a grating or an interference filter is varied in order to change the wavelength of the transmission peak. The filter of this kind has a single transmission peak, i.e., single-peak narrow-bandwidth (SPNB), whose FWHM is typically 20˜100 GHz. A tunable filter of a narrower bandwidth is difficult to make.

Neither of the above mentioned methods can produce a filter with a bandwidth of 1 GHz or less, for the entire C- or L-band of about 5000 GHz.

### SUMMARY OF THE INVENTION

This disclosure describes embodiments of various high resolution fast tunable optical filters. Generally, each filter includes a single-peak narrow-bandwidth (SPNB) filter and a tunable etalon in tandem with the SPNB filter, where the bandwidth of the SPNB filter is less than the free spectral range (FSR) of the tunable etalon. One type of fast filter includes an interference bandpass filter. In that type of embodiment, as well as a method of its operation, the SPNB includes an interference bandpass filter positioned to transmit an input beam of light a first time to produce transmitted light; a first wave plate positioned to rotate the polarization of the transmitted light to produce first rotated light; and a reflector positioned to reflect the first rotated light so that it propagates through the wave plate a second time to produce second rotated light, where and second rotated light passes through the interference filter a second time to produce second transmitted light, where the tunable etalon is operatively positioned such that the input beam passes through the tunable etalon prior to being transmitted by the interference bandpass filter a first time.

Another type of fast filter includes a diffraction grating. In that type of embodiment, as well as a method of its operation, the SPNB filter includes an input port for receiving input light of multiple wavelengths; a first adjustable mirror positioned to reflect at least a portion of input light to produce reflected light; a diffraction grating positioned to diffract the reflected light into different wavelength components to produce diffracted light; means for directing the diffracted light back towards the first adjustable mirror; and means for adjusting the direction of the first adjustable mirror so that a selected wavelength of the different wavelength components will propagate to an output port, where the etalon is operatively positioned between the input port and the first adjustable mirror such that the input light passes through the etalon before being reflected by the first adjustable mirror.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows the transmission peaks of an etalon and a SPNB filter.

FIG. 2A shows a system block diagram where the transmission spectrum of DUT is measured by the photo detector (PD), where the etalon and the SPNB filter are in tandem.

FIG. 2B shows the system if FIG. 2A with the inclusion of a circulator.

FIG. 3 shows a tunable interference filter (angle-tuning) in cascade with an etalon.

FIG. 4A shows an etalon connected to a tunable SPNB filter.

FIG. 4B shows a transmission grating and mirror that can be substituted into the embodiments of FIGS. 4A, 5 and 6.

FIG. 5 shows a tunable etalon packaged in the collimated-beam space of a tunable SPNB filter, which has a single-fiber collimator.

FIG. 6 shows a tunable etalon packaged in the collimated-beam space of a tunable SPNB filter, which has a dual-fiber collimator.

### DETAILED DESCRIPTION OF THE INVENTION

To reduce the bandwidth of an etalon, one can increase Finesse and/or reduce FSR. For instance, if FSR=25 GHz and Finesse=50, then FWHM=0.5 GHz. However, reducing the FSR leads to a multiple-peak situation. In other words, there are multiple peaks within the tuning range of the etalon.

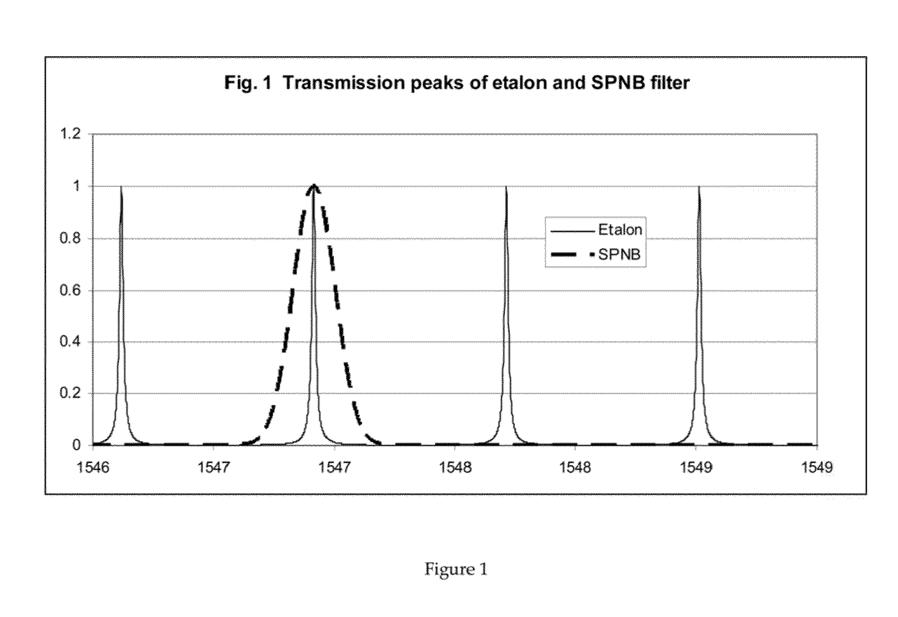

By adding the above mentioned SPNB filter to the light path of an etalon or vice versa, we can change the multiple-peak situation to a single-peak one, as shown in FIG. 1. When the cavity length of an etalon is fixed, the multiple peaks of the etalon transmit the spectrum of a device under test (DUT) at multiple wavelengths, with a resolution determined by the etalon. In other words, the spectrum of the DUT is sampled by the etalon.

A scanning SPNB filter will transmit sequentially the DUT spectrum at those sampling points, determined by the etalon. The profile around each sampling point is now broadened in a similar way as a single delta function convolved with a finite-width filter. Because each delta function of the comb filter is far away from each other, the corresponding maximum of the profile represents the spectrum of the DUT at the sampling point, and, hence, reflects the true spectrum of the DUT.

In the next step, we increase the cavity length by a distance equal to a fraction of the wavelength, for instance, 1%. The cavity length of the etalon can be adjusted by thermally tuning the etalon. Thus, the wavelength of every transmission peak of the etalon shift b an amount equal to 2% of FSR. The spectrum of the DUT is sampled by the etalon at the new wavelengths. A scanning SPNB filter will transmit sequentially the DUT spectrum at the new sampling point, determined by the etalon. Repeating this for 50 times, the DUT is sampled at 50 wavelengths within every FSR. As a result, the resolution is equal to 1 GHz for a 50 G comb filter. The entire spectrum of the DUT can be reconstructed from the 50 scans, by simply interlacing the data according to the order of the scan. Using a smaller increment for the cavity length change can provide a better resolution. Two examples of the tunable SPNB filter are given in U.S. patent application Ser. No. 13/441,899, incorporated by reference and in U.S. patent application Ser. No. 13/633,005, incorporated by reference. Using a MEMS device, the tuning speed can be as small as a few ms. In summary, a high-resolution fast spectrometer is achieved with a resolution of few ppm over the entire C-hand within one or two seconds.

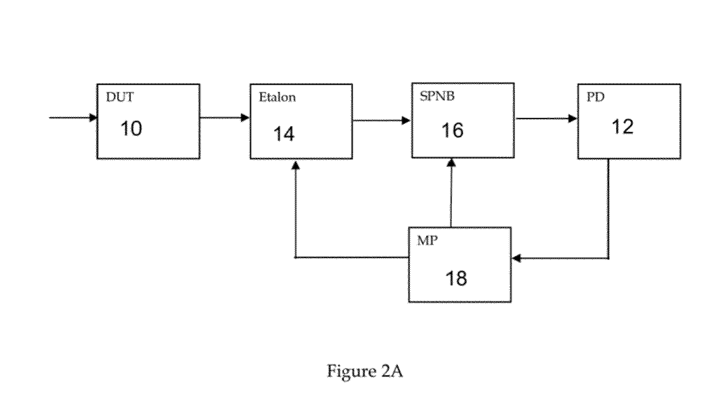

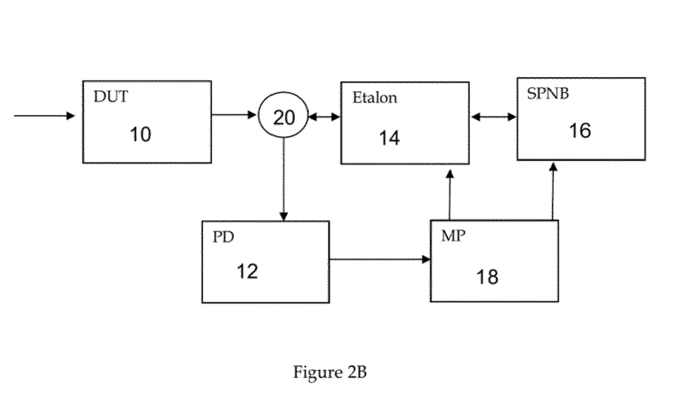

FIG. 2A show a system block diagram where the transmission spectrum of DUT 10 is measured by the photo detector (PD) 12, where the etalon 14 and the SPNB filter 16 are in tandem and controlled by the micro-processor (MP) 18 to acquire several scans. Notice that the order of Etalon and SPNB filter can be exchanged. In each scan, multiple peaks are obtained. The profile of each scan is stored and is used to reconstruct the spectrum of DUT. FIG. 2B shows the system of FIG. 2A with the inclusion of a circulator 20.

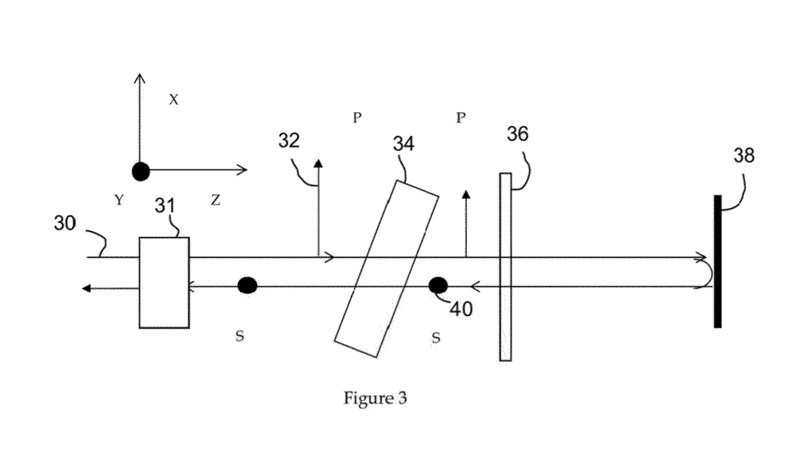

FIG. 3 shows a tunable interference filter (angle-tuning) in cascade with an etalon. In the figure, an etalon precedes a quarter wave plate inserted between a tilted interference filter and a mirror. The quarter wave plate is oriented such that its polarization axis is 45 degrees with respect to the direction of P-polarization (X-axis). The beam passes through the ¼ wave plate and is reflected by a mirror so that the beam propagates through the ¼ wave plate a second time. The combination of the ¼ wave plate and the mirror functions as a half wave plate. The polarization of the reflected beam is changed from P-polarization to S-polarization after the beam goes through the ¼ wave plate twice. Referring specifically to FIG. 3, input beam 30 has a P-polarized component as indicated by reference number 32. After passing through etalon 31 and the interference filter 34, the beam retains its P polarization. This beam then passes through ¼ wave plate 36 which turns the P-polarized light to a circularly polarized light. This beam is then reflected from mirror 38 and passes through wave plate 36 a second time to convert the circularly polarized light to a S-polarization (40) relative to the interference filter.

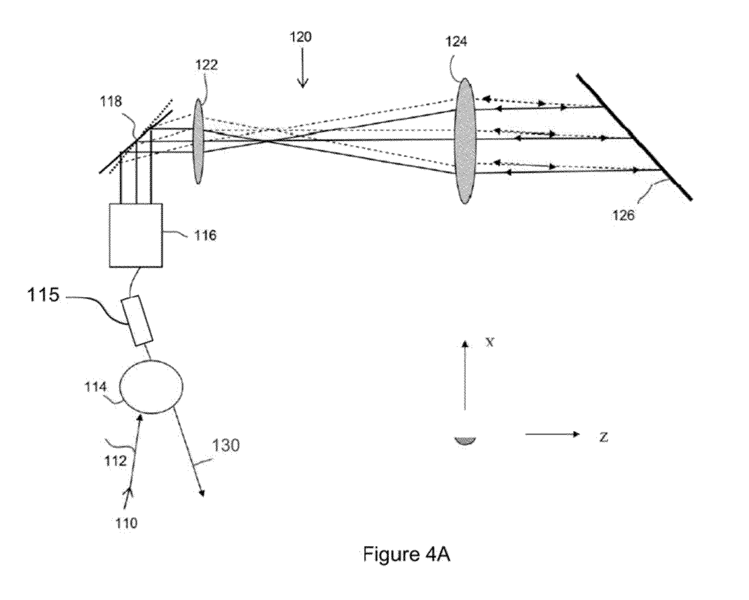

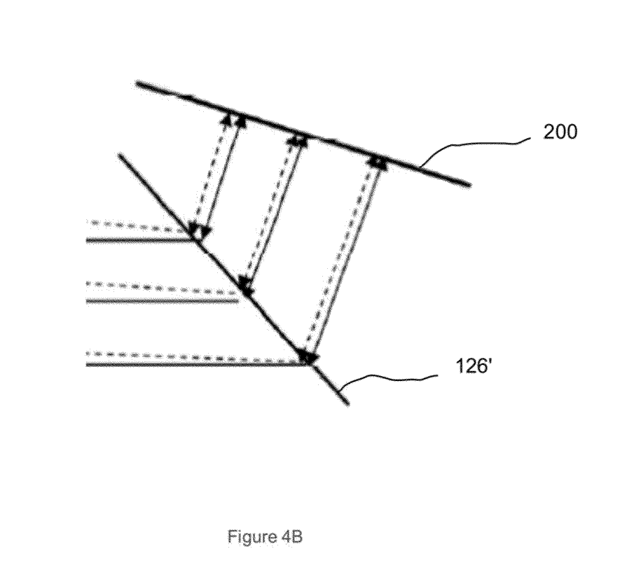

FIGS. 4-6 of the present case are modifications of the embodiment of FIG. 2 of U.S. patent application Ser. No. 13/441,899. Identical elements of FIGS. 4-6 are given identical reference numbers. Based on the disclosure herein, those skilled in the art will understand that the embodiments of FIGS. 3-6 of U.S. patent application Ser. No. 13/441,899 can also be modified to include an etalon in the same manner as described in the exemplary embodiments described herein and are thus within the scope of the present invention. FIG. 4A of the present case shows an etalon connected to a tunable SPNB filter. This design uses a reflection grating, but a transmission grating can also be used. The reflection grating 126 of FIG. 4A can be replaced with the transmission grating 126′ of FIG. 4B, which is followed by a mirror 200. An input beam 110 comprising a spectrum of wavelengths is directed into input fiber 112 of circulator 114. Input fiber 112 can be referred to as an input port. Further, any means for injecting light into the system can be referred to as an input port. The beam passes through in-line fiber etalon 115 (e.g., a fiber pigtailed Fabry-Perot etalon) and is collimated by input/output collimator 116. The collimated beam impinges onto a mirror 118 that is mounted on a rotation actuator. After beam 110 is reflected by mirror 118, it is magnified by beam expander 120, which comprises magnification optics 122 and 124, which are both positive lenses in this case. Beam 110 then propagates onto and is reflected by reflecting diffraction grating 126. Only a small portion of the wavelength spectrum of the reflected beam will be reflected back along the incoming path and then propagate to output fiber 130, which can be referred to as an output port. Any means for gathering light output from this system can be referred to as an output port.

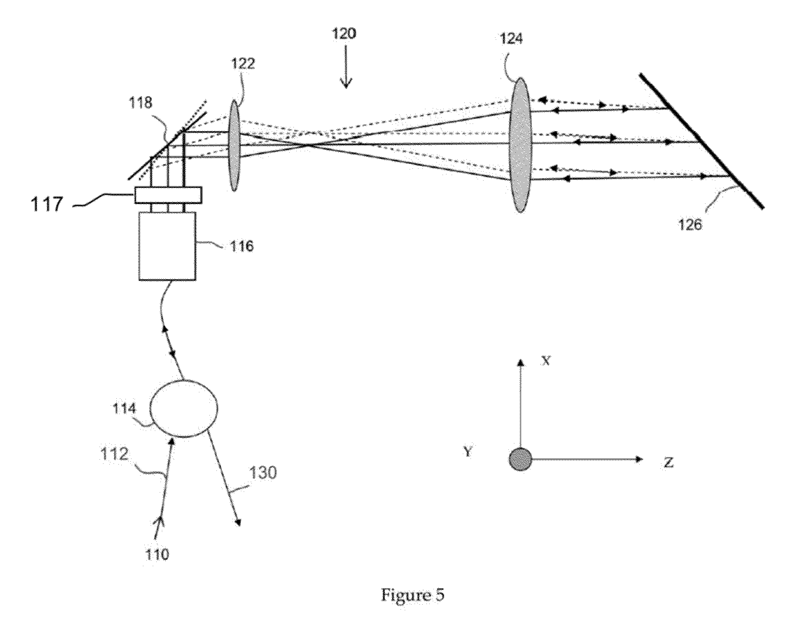

FIG. 5 shows a tunable etalon packaged in the collimated-beam space of a tunable SPNB filter, which has a single-fiber collimator. This design uses a reflection grating, but a transmission grating can also be used as discussed above. An input beam 110 comprising a spectrum of wavelengths is directed into input fiber 112 of circulator 114. Input fiber 112 can be referred to as an input port. Further, any means for injecting light into the system can be referred to as an input port. The beam passes is collimated by input/output collimator 116. The collimated beam passes through etalon 117 and then impinges onto a mirror 118 that is mounted on a rotation actuator. After beam 110 is reflected by mirror 118, it is magnified by beam expander 120, which comprises magnification optics 122 and 124, which are both positive lenses in this case. Beam 110 then propagates onto and is reflected by reflecting diffraction grating 126. Only a small portion of the wavelength spectrum of the reflected beam will be reflected back along the incoming path and then propagate to output fiber 130, which can be referred to as an output port. Any means for gathering light output from this system can be referred to as an output port.

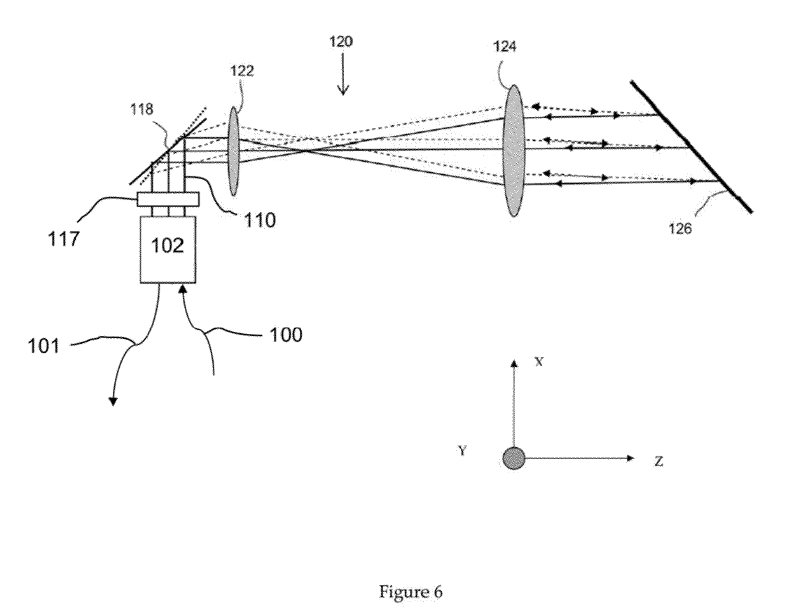

FIG. 6 shows a tunable etalon packaged in the collimated-beam space of a tunable SPNB filter, which has a dual-fiber collimator. This design uses a reflection grating, but a transmission grating can also he used as discussed above. An input beam (110) comprising a spectrum of wavelengths is directed into input fiber 100 of dual-fiber collimator 102. Input fiber 100 can be referred to as an input port. Further, any means for injecting light into the system can be referred to as an input port. The beam is collimated and then passes through etalon 117 and then impinges onto a mirror 118 that is mounted on a rotation actuator. After beam 110 is reflected by mirror 118, it is magnified by beam expander 120, which comprises magnification optics 122 and 124, which are both positive lenses in this case. Beam 110 then propagates onto and is reflected by reflecting diffraction grating 126. Only a small portion of the wavelength spectrum of the reflected beam will reflected back to output fiber 101, which can be referred to as an output port. Any means for gathering light output from this system can be referred to as an output port.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A high resolution fast tunable optical filter, comprising:
a tunable single-peak narrow-bandwidth (SPNB) filter; and
a tunable etalon in tandem with said SPNB filter, wherein the bandwidth of said SPNB filter is less than the free spectral range (FSR) of said tunable etalon.

2. The high resolution fast tunable optical filter of claim 1, wherein said SPNB comprises:
an interference bandpass filter positioned to transmit an input beam of light a first time to produce transmitted light;
a first wave plate positioned to rotate the polarization of said transmitted light to produce first rotated light; and
a reflector positioned to reflect said first rotated light so that it propagates through said wave plate a second time to produce second rotated light, wherein and second rotated light passes through said interference filter a second time to produce second transmitted light, wherein said tunable etalon is operatively positioned such that said input beam passes through said tunable etalon prior to being transmitted by said interference bandpass filter a first time.

3. The high resolution fast tunable optical filter of claim 1, wherein said SPNB filter comprises:
an input port for receiving input light of multiple wavelengths;
a first adjustable mirror positioned to reflect at least a portion of input light to produce reflected light;
a diffraction grating positioned to diffract said reflected light into different wavelength components to produce diffracted light;
means for directing said diffracted light back towards said first adjustable mirror; and
means for adjusting the direction of said first adjustable mirror so that a selected wavelength of the different wavelength components will propagate to an output port, wherein said etalon is operatively positioned between said input port and said first adjustable mirror such that said input light passes through said etalon before being reflected by said first adjustable mirror.

4. The high resolution fast tunable optical filter of claim 1, further comprising means for tuning said SPNB filter at a first maximum speed and further comprising means for tuning said tunable etalon at a second maximum speed, wherein said first maximum speed is greater than said second maximum speed.

5. The high resolution fast tunable optical filter of claim 1, further comprising means for scanning said SPNB filter with a frequency tuning range equivalent to a plurality of FSR of said tunable etalon.

6. The high resolution fast tunable optical filter of claim 1, wherein said SPNB filter includes an angle-tunable interference filter.

7. The high resolution fast tunable optical filter of claim 1, wherein said SPNB filter includes a grating.

8. The high resolution fast tunable optical filter of claim 3, wherein said tunable etalon comprises an in-line fiber optic etalon.

9. The high resolution fast tunable optical filter of claim 3, further comprising means for collimating said input light such that said input light is collimated as it passes through said etalon.

10. The high resolution fast tunable optical filter of claim 3, further comprising a photo detector positioned to receive the optical power of said selected wavelength, further comprising means for interlacing multiple scans of said high resolution fast tunable optical filter according to the order of the scan to reconstruct the spectrum of an incoming optical signal under test.

11. The high resolution fast tunable optical filter of claim 3, wherein said grating comprises a transmission grating.

12. The high resolution fast tunable optical filter of claim 1, further comprising means for thermally tuning said etalon.

13. The high resolution fast tunable optical filter of claim 3, further comprising a fiber optic circulator, wherein said input port is an input fiber of said fiber optic circulator and wherein said output port is an output fiber of said fiber optic circulator.

14. The high resolution fast tunable optical filter of claim 3, wherein said diffraction grating comprises a reflecting grating operably fixed such that it functions as said means for directing.

15. A method, comprising:
providing the high resolution fast tunable optical filter of claim 3;
receiving input light of multiple wavelengths into said input port, wherein said input light propagates through said etalon to produce transmitted light;
reflecting said transmitted light with said first mirror to produce reflected light;
diffracting, with said diffraction grating, said reflected light into different wavelength components to produce diffracted light;
directing said diffracted light back towards said first mirror; and
adjusting the direction of said first mirror so that a selected wavelength of the different wavelength components will propagate to said output port.

16. The method of claim 15, further comprising tuning said SPNB filter at a faster speed than said tunable etalon.

17. The method of claim 15, further comprising scanning said SPNB filter with a frequency tuning range equivalent to a plurality of FSR of said tunable etalon.

18. The method of claim 15, wherein said SPNB filter includes an angle-tunable interference filter.

19. The method of claim 15, wherein said SPNB filter includes a grating.

20. The method of claim 15, wherein said tunable etalon comprises an in-line fiber optic etalon.

21. The method of claim 15, further comprising collimating said input light such that said input light is collimated as it passes through said etalon.

22. The method of claim 15, further comprising interlacing multiple scans of said high resolution fast tunable optical filter according to the order of the scan to reconstruct the spectrum of an incoming optical signal under test.

23. The method of claim 15, wherein said grating comprises a transmission grating.

24. The method of claim 15, further comprising thermally tuning said etalon.

25. The method of claim 15, further comprising a fiber optic circulator, wherein said input port is an input fiber of said fiber optic circulator and wherein said output port is an output fiber of said fiber optic circulator.

26. The method of claim 15, wherein said diffraction grating comprises a reflecting grating operably fixed such that it functions as said means for directing.
